(19) United States
(12) Patent Application Publication
(10) Pub. No.: US 2014/0183291 A1
(43) Pub. Date: Jul. 3, 2014

(54) Grinding roller comprising hard bodies embedded in the surface

(71) Applicant: Meinhard Frangenberg, Kuerten-Engelskirchen (DE)

(72) Inventor: Meinhard Frangenberg, Kuerten-Engelskirchen (DE)

(73) Assignee: KHD Humboldt Wedag GmbH, Köln (DE)

(21) Appl. No.: 14/128,768

(22) PCT Filed: Jun. 19, 2012
(86) PCT No.: PCT/EP2012/002576

§ 371 Date: Dec. 23, 2013

(30) Foreign Application Priority Data
Jun. 21, 2011 (DE) 10 2011 104 854.9

(51) Int. Cl. B02C 4/30

(52) U.S. Cl. CPC B02C 4/30
USPC 241/294; 29/426.5; 29/426.4

(57) ABSTRACT

A grinding roller comprising hard bodies embedded in the surface for fixing a material bed. The hard bodies are received in a sleeve respectively and are embedded in the surface. As a result, the sleeves can be removed more easily from the surface after use and wear of the grinding roller for restoring the surface.

### CROSS-REFERENCES TO RELATED APPLICATIONS

This application claims the benefit of the German patent application No. 10 2011 104 854.9 filed on Jun. 21, 2012, the entire disclosures of which are incorporated herein by way of reference.

### BACKGROUND OF THE INVENTION

The invention relates to a grinding roller comprising hard bodies embedded in the surface for fixing a material bed and methods for removing the hard bodies.

For the comminution of granular bulk material, it is known to introduce the granular bulk material into the nip of a high-pressure roller press and to comminute it there with the aid of a high nip pressure. The particular feature of this method, which is described as high-pressure comminution by Schonert et al. in German Laid-Open Publication DE2708053A1, is that the rollers rotate contradirectionally without slip and comminute the grinding stock solely by the use of a high pressure, but not by shearing in the roller nip. As a result, a high comminution performance with a high energy yield is obtained. Comminution in the roller nip is particularly suitable for brittle materials.

In order to mitigate the high abrading action which prevails in spite of the absence of roller slip, it is known to introduce on the surface of the grinding rollers hard bodies between which a bed is formed from the grinding stock itself to be ground and solidifies there, thus acting as autogenous wear protection. In addition to the straightforward action to anchor the material bed forming on the surface of the grinding roller, the hard bodies also result in an improved draw-in behavior of the grinding rollers. To be precise, in order to obtain an optimal comminuting action, it is important that the roller nip of the roller mill is fed with a specific quantity of grinding stock per unit time in order to achieve an optimal comminution behavior. German patent specification DE4036040C2 discloses initial approaches for equipping a grinding roller with an autogenous wear protection layer during use. This technique was improved later in EP0516952B1.

In spite of the autogenous wear protection layer, which is present during the operation of the grinding roller between the hard bodies projecting in a hedgehog-like manner from the roller surface, the grinding roller has a limited service life, depending on the nature of the grinding stock. Some applications of this grinding technology, such as, for example, the comminution of cement clinker, by means of a high-pressure roller press enable the grinding rollers to be used for several thousand hours until they are worn to an extent such that the desired grinding performance can no longer be achieved. A use of this grinding technology to comminute other materials, such as, for example, ores, even enables the grinding rollers to have a service life of up to 10 000 hours until a repair of the surface or even an exchange of the grinding roller is necessary. When the grinding roller becomes worn to a degree which makes its use no longer economically viable, a bathtub effect, as it is known, arises, in which the grinding roller exhibits more wear in the axial center than at the margins of the grinding roller and therefore the grinding roller acquires a slightly waisted form. In a grinding roller profile formed in this way, the necessary pressure can no longer be built up in the roller nip, with the result, on the one hand, that comminution becomes more energy-intensive and with the result, on the other hand, that the throughput of the roller presses decreases because circulated grinding stock has to pass through the grinding roller more than once and up to several times until it is cleaned out of the grinding circuit by a separator. This pattern of wear is not only caused by the fact that the grinding stock is administered centrally to the roller nip, but also because the grinding stock located in the roller nip exhibits plastic to liquid-like properties and, during the short passage time through the roller nip, seems to flow towards the margins of the grinding rollers. During this lateral movement of the grinding stock, the surface is slowly stripped off In addition to the pronounced stress caused in the roller nip by rock which has a fluid-like behavior, because of the very high pressure the grinding roller performs a tumbling movement which is outwardly similar to that of a rolling car tire. The tumbling movement is the reason why the surface of the grinding roller is subjected to very high mechanical stress. In further development of the grinding rollers, it was shown that a forged surface leads to an especially long service life of the grinding roller.

If the grinding roller is to be upgraded in order to restore the original cylindrical form, it is necessary to remove at least some of the hard bodies from the surface of the grinding roller. Since, as hard bodies become smaller, the adhesion of the autogenous wear protection layer is improved up to a limit point, the aim is to introduce as many hard bodies as possible into the surface of the grinding rollers. A number of 22 000 hard bodies in a grinding roller is not unusual in this case.

When a grinding roller becomes worn, it can be upgraded again by the removal of the hard bodies which have still remained, by the lathe-turning of the grinding roller to a cylindrical form and by the new embedding of hard bodies. Admittedly, the draw-in angle according to Schonert et al. is consequently changed, because the diameter of the grinding roller is reduced after this type of upgrading and therefore the parameters of nip passage are modified. However, the costs of the grinding roller, which are high because of the high outlay in manufacturing terms, justify this type of upgrading, insofar as it makes removal of the hard bodies economically viable.

The result of using forged bands for a grinding roller is that, on the one hand, the initially described tumbling movement and the ductility of the roller material or the roller band cause the hard bodies to be driven firmly into the remaining bore, the borehole margins bearing closely against the hard body surface due to a plastic deformation. Furthermore, at the margin of the remaining bore in the worn surface of the grinding roller, that is to say at the neck of the hard body, small grinding stock splinters are driven in firmly between the bore margin and the hard body neck and fix the hard body in the surface in the manner of a wedge. Consequently, a high outlay in terms of apparatus and in manual terms is necessary in order to remove the individual hard bodies from the respective bore. The fact that the hard bodies are glued in the bore is the least problem here since the adhesive may become carbonized or pyrolyzed or burnt due to heat treatment. The mechanical pulling of the hard bodies is very complicated on account of the plastic deformation of the surface of the grinding roller. There has, admittedly, been a move to use hard bodies having a recess which can receive a tool for twisting the hard bodies and breaking them out of the surface, as described in DE10200601042A1 and in DE102009039928B3. However, tubular hard bodies are necessary for this purpose, which, depending on the nature of the grinding stock, have in use a shorter service life, as compared with conventional hard bodies, and may become worn or break more quickly. Nowadays, for removal, in grinding rollers not equipped with a ductile surface, the adhesive of the hard bodies is carbonized and subsequently pulled by means of a tool, pulling having to be repeated more than once, if appropriate, in order to be successful. Further methods provide for welding a weld spot, a pulling tool or a hook to the hard body, the hard bodies being composed of a non-oxidic ceramic and therefore welding also being comparatively complicated and having little strength. If welding is unsuccessful, the surface of the hard body head is possibly stripped off, and removal by pulling is made more difficult. In another method for removing the hard bodies, the hard bodies are provided as the core of a hollow bore, a hollow drill using the hard body for centering. The roller material is drilled out around the hard body and the hard body is finally released. With 22 000 and, where appropriate, even more hard bodies per individual grinding roller, this method for removing the hard bodies entails a high outlay and is scarcely viable any longer economically.

However, it would be desirable to equip a surface with conventional hard bodies which can be removed at comparatively little outlay for the purpose of upgrading or repairing limited surface segments.

### SUMMARY OF THE INVENTION

The aim of the invention, therefore, is to make available a grinding roller comprising hard bodies introduced into the surface, the hard bodies of which can be removed at a lower outlay than is necessary in the prior art.

The object according to the invention is achieved in that the hard bodies are accommodated in each case in a sleeve and are inserted into the surface. Further advantageous refinements are specified in subclaims 2 to 7. Methods for removing these hard bodies are specified in method claims 8 to 10.

The use of a sleeve makes it possible to loosen the hard bodies in a simplified way from the surface of the grinding roller which, because of its material properties, is ductile and is deformed plastically during use as a result of tumbling movements and consequently firmly surrounds the respective hard body. Insofar as the sleeve is made from a material which is identical to the material of the surface of the grinding roller, a weld spot can be applied to the sleeve and the sleeve pulled together with the hard body. In this case, the mechanical effort to pull the grinding roller is not made appreciably easier, but the material properties of the sleeve, which is identical to the material of the surface, make it markedly easier to weld on the weld spot.

In an embodiment of the invention, there is provision whereby the sleeve and/or the hard body are/is shaped conically inside the bore. For this purpose, the diameter at the bore margin, level with the surface, is larger than at the bottom or below the surface. The conical arrangement makes it possible to pull the sleeve, together with the hard body, more easily. Since the cone widens towards the surface, it is to be assumed that the cone is pressed out of the surface of the grinding roller as a result of the tumbling movement of the grinding roller and due to the plastic deformation of the surface. However, in tests, it has not been observed that the cone is pressed out counter to the nip pressure.

The cone of the hard body and/or of the sleeve may be shaped in various ways. A simple conical sleeve is formed cylindrically inside and is formed conically at the outer margin, the bore in the surface of the grinding roller being formed to match this.

In a further embodiment of the hard body, together with the sleeve, there is provision whereby the hard body is formed conically and is tapered toward the head. The seat of the hard body, that is to say the bore in the surface of the grinding roller, is, however, formed cylindrically. The sleeve accommodates the conical hard body inside it and for this purpose has a smaller wall thickness toward the hard body foot.

Finally, a double-conical embodiment is also provided, in which a conical hard body is accommodated by a sleeve which fits the hard body into a conical bore, the hard body being tapered toward the head and the bore being tapered toward the hard body foot.

In a special embodiment, there is provision whereby the sleeve is laid as a clamping ring around the hard body and is therefore open. In this case, the clamping ring may be thick-walled or thin-walled, depending on the choice of material. The thick-walled sleeve is formed around the hard body, whereas the thin-walled sleeve, if this is composed, for example, of spring steel, is tensioned around the sleeve.

In a more specific embodiment of the invention, the sleeve is composed of two individual sleeves of different material or of a composite material which has different materials in axial direction. In this case, a less wear-resistant, but instead more easily removable material is introduced in the ring-shaped space between the hard body foot and the lower bore, and the ring-shaped space, which points toward the surface of the grinding roller, is equipped with an especially wear-resistant material or with a material identical to the material of the surface. The layer thickness of the upper material is in this case dimensioned such that it corresponds to the maximum depth of wear of the grinding roller. When maximum wear is reached, the easily removable sleeve is released. This can then be removed for upgrading.

The material of an easily removable sleeve may have an especially low melting point or else exhibit an especially negative chemical standard potential so that it can be oxidized comparatively easily. The low-melting material can be removed by heating the surface and the material having the negative chemical standard potential can be removed by electrochemical etching. In a similar way to a sacrificial anode on a ship, this material is preferably dissolved electrochemically or electrolyzed before the material of the surface of the grinding roller is electrolyzed when the grinding roller is dipped completely or partially into an electrolyte solution and is oxidized anodically.

It is precisely the latter method that is especially suitable for being carried out in places of use of the grinding roller which lie at remote locations, such as desert regions or minefields equipped with poor infrastructure. The electrochemical oxidation of the sleeve having a more negative standard potential than the surface of the grinding roller may last some time. During this time, however, there is no need for any special outlay in terms of apparatus or manual terms, and therefore the removal of the hard bodies can be left almost to itself Since the hard bodies are usually composed of tungsten carbide which is chemically resistant, the hard body residue can be recovered in order to deliver it for chemical processing to recover the tungsten.

### BRIEF DESCRIPTION OF THE DRAWINGS

The invention is explained in more detail by means of the following figures in which:

FIG. 1 shows a hard body in a cylindrical sleeve,

FIG. 2 shows a conical hard body in a conical sleeve in a cylindrical bore,

FIG. 3 shows a cylindrical hard body in a conical sleeve,

FIG. 4 shows a conical hard body in a conical bore with a double-conical sleeve,

FIG. 5 shows a hard body with a waisted body which is clamped round by an open sleeve,

FIG. 6 shows a hard body with two sleeves made from different material,

FIG. 7 shows the depiction of a detail of a grinding roller surface which is freed of sleeves electrolytically.

### DETAILED DESCRIPTION OF THE PREFERRED EMBODIMENTS

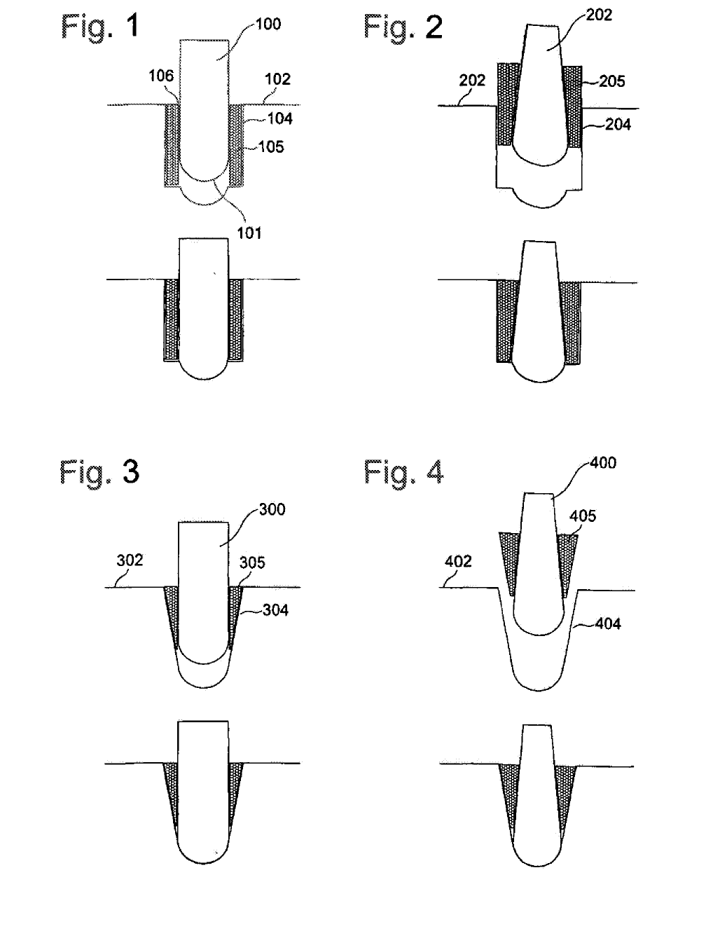

FIGS. 1 to 4 and 6 are illustrated in each case in an upper and a lower part figure, in each case the upper part figure illustrating the state before embedding and in each case the lower part figure illustrating the embedded state of the hard body and of the sleeve in the surface of a grinding roller.

FIG. 1 illustrates a cylindrical hard body 100 with a spherical foot 101 which is embedded into the surface 102 of a grinding roller. Between the cylindrical hard body 100 and the bore wall 104 is arranged a sleeve 105 which makes it possible to remove the hard body 100 after use. In this embodiment, both the outside diameter of the hard body 100 and the inside diameter of the bore wall 104 are cylindrical, so that the sleeve 105 can be characterized as cylindrical/cylindrical with regard to the sleeve shape and bore shape. To remove the hard body 100 and sleeve 105, there is provision for applying a weld spot to that point on the sleeve 105 which is visible toward the surface 102 and pulling the sleeve 105 out of the bore with the aid of the weld spot which has a hook, tube or pin for gripping.

For this embodiment, the material of the sleeve 105 is preferably made from the same material as the material of the surface 102 of the grinding roller.

Alternatively, it is also possible to produce the sleeve 105 from a material having a low melting point which should preferably lie below 400° C. The 400° C. limit is due to the tendency of the surface material, insofar as it is composed of ADI (Austempered Ductile Iron), to pass through phase transformation which hardened forging materials also pass through, for example, at this temperature. If the sleeve material therefore melts below this temperature, removal is possible by uniformly heating the surface, for example with the aid of a flame, during which the material is melted and discharged, the hard body then being pulled. Materials which melt at these low temperatures are usually highly sensitive to wear. Since the wear of the surface material of the grinding roller also occurs precisely at the neck 106 of the hard body 100, it is beneficial, in the choice of the material meltable at low temperature, if the sleeve 105 is very thin-walled. The sleeve material can be liquefied by heating, so that the hard body 100 is seated, as through it were soldered in, in the surface 102 of the grinding roller. This gives rise in the surface 102 to a gap-free seat of the hard body 100 which is free of grinding stock granules which penetrate into the gap and usually wedge the hard body 100 in the bore. When the grinding roller is in operation, it will be noticeable that the neck 106 or the upper part of the sleeve 105 acts as though it were washed out, but this effect decreases after a short depth because a layer of firmly seated grinding stock builds up in the annular space between the hard body 100 and bore wall 104 and thus forms an autogenous wear protection layer for the sleeve 105.

In the most particular embodiment, the sleeve 105 is made from a material which has a more negative chemical standard potential than the material of the surface 102 of the grinding roller. For removal, the grinding roller is dipped into an electrolyte bath, the grinding roller needing to be placed in a tub having a depth of only about 10 to 20 cm, so that the hard bodies 100 lying bottommost are dipped into the electrolyte solution. To release the hard bodies 100, the entire grinding roller is connected to the anode of a powerful electrical voltage source and virtually any electrode, preferably a platinized or graphitized electrode is used as an antipole. To carry out electrolysis, the electrical voltage is set such that fine bubbles 110 of hydrogen are formed on the sleeves 100, as illustrated in FIG. 9, and indicate the start of electrolysis. The electrical voltage selected should not be so high that the surface 102 also begins to decompose, this being indicated by the formation of bubbles. Since the sleeve material has a more negative standard potential than the material of the surface of the grinding roller, it is decomposed first virtually as a sacrificial anode. The electrolytic decomposition process may perfectly well require several days to weeks because, during electrolysis, the surface of the sleeve 105 always lies deeper in the annular space between the hard body 100 and bore and is exposed to the electrolyte solution. In this time, however, only a very low outlay in monitoring terms is necessary; if appropriate, the grinding roller has to be rotated in a shallow bath. This type of release of the hard bodies 100 from the surface can therefore be left to itself and can consequently be carried out highly cost-effectively. Above all, it is possible to carry out this type of treatment, even at remote locations where there are mines, with little specialized knowledge and expert training.

FIGS. 2 to 4 illustrate various embodiments of the hard bodies/sleeve pair which, as referred to above, can be characterized by conical/cylindrical in FIG. 2, cylindrical/conical in FIG. 3 and conical/conical in FIG. 4.

The conical/cylindrical form according to FIG. 2 holds the hard body 200 very firmly, but the sleeve 205 has a larger surface exposed to the grinding stock. This sleeve form is therefore suitable for sleeve material made from the material of the surface of the grinding roller itself To remove the hard body, it is best here to employ the method with the aid of the weld spot which is applied to the sleeve 205.

The cylindrical/conical form according to FIG. 3 is likewise suitable for material made from the surface material of the grinding roller, this form being suitable for the further use of existing hard bodies 300 which are regularly shaped cylindrically in the prior art.

Finally, the conical/conical form according to FIG. 4 is suitable for grinding rollers which are subjected to especially high stress and in which the sleeves 400 are fixed especially intensively as a result of the plastic deformation of the surface material.

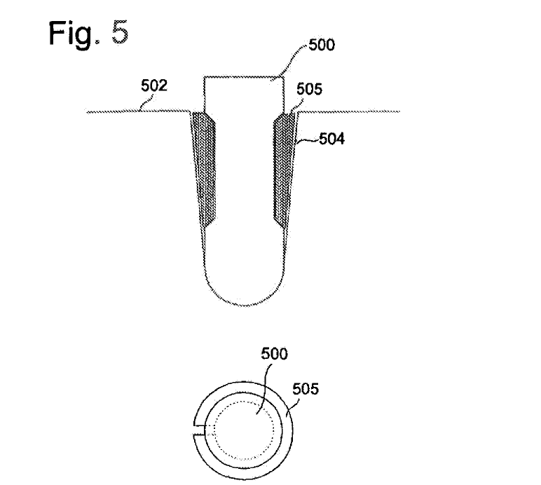

Finally, FIG. 5 illustrates a combination of a hard body 500 and of a sleeve 505, the sleeve 505 being shaped as an open ring around the hard body 500, the hard body 500 being waisted in this combination. If a thick-walled sleeve 505 is used, the sleeve 505 can be laid around the hard body 505 by hot forming before insertion into the bore 504. If a thin-walled sleeve 505 is used, this, insofar as it is made from spring steel, can be tensioned around the sleeve 500. This embodiment has the advantage that the hard bodies 500 can be prefabricated in large quantities as the hard body/sleeve combination, with the result that fitting is simplified correspondingly.

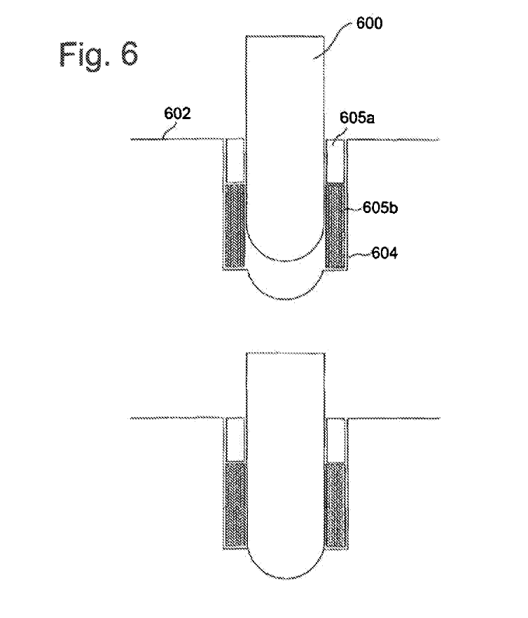

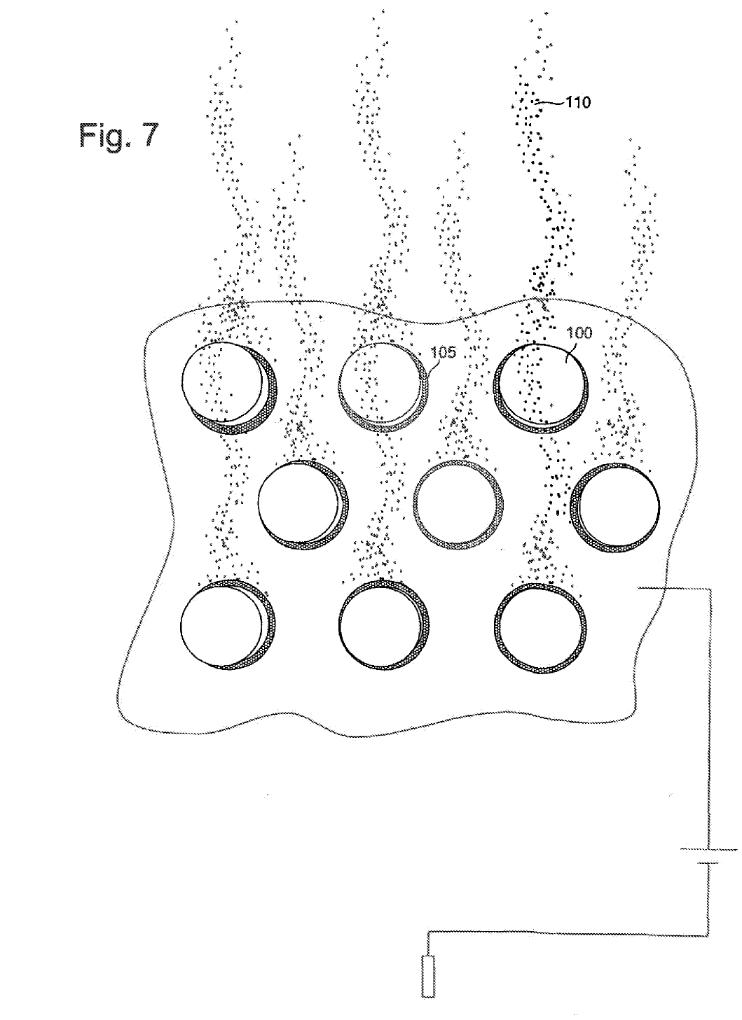

A special embodiment is shown in FIG. 6, a cylindrical/cylindrical configuration being selected here which is representative here of the embodiments described in the figures described above. A particular feature of this embodiment is that two sleeves 605a and 605b stand one above the other in the bore 604 and retain the hard body 600. In this case, the material of the lower sleeve 605b countersunk in the annular space between the hard body 600 and bore 604 is made from low-melting material or from material having a negative chemical standard potential. By contrast, the upper sleeve 605a is made from the same material as the material of the grinding roller surface. During use, the upper sleeve 605a is abraded just as quickly as the rest of the surface, so that, with maximum acceptable wear, the lower sleeve 605b is exposed and can be removed by means of the abovementioned methods.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

LIST OF REFERENCE SYMBOLS

| | |
|---|---|
| 100 | Hard body |
| 101 | Foot |
| 102 | Surface |
| 104 | Bore wall |
| 105 | Sleeve |
| 106 | Neck |
| 110 | Bubble |
| 200 | Hard body |
| 202 | Surface |
| 204 | Bore |
| 205 | Sleeve |
| 300 | Hard body |
| 302 | Surface |
| 304 | Bore |
| 400 | Hard body |
| 402 | Surface |
| 404 | Bore |
| 405 | Sleeve |
| 500 | Hard body |
| 502 | Surface |
| 504 | Bore |
| 505 | Sleeve |
| 600 | Hard body |
| 602 | Surface |
| 604 | Bore |
| 605a | Sleeve |
| 605b | Sleeve |

1-10. (canceled)

11. A grinding roller having an outer surface with a plurality of hard bodies embedded in the surface for fixing a material bed, the hard bodies each being accommodated in a separate sleeve, said sleeves being inserted into the surface.

12. The grinding roller as claimed in claim 11, wherein at least one of the sleeve and the hard bodies are shaped conically inside an accommodation bore in the surface of the grinding roller.

13. The grinding roller as claimed in claim 11, wherein the sleeve partially surrounds the respective hard body as an open ring.

14. The grinding roller as claimed in claim 11, wherein each sleeve is covered by one of a further sleeve and a ring made from a material which is identical to a material of the surface of the grinding roller.

15. The grinding roller as claimed in claim 11, wherein the material of the sleeve has a melting point of 400° C. or less.

16. The grinding roller as claimed in claim 11, wherein the material of the sleeve has a chemical standard potential which is lower, that is, more negative, than that of the surface of the grinding roller.

17. The grinding roller as claimed in claim 11, wherein the hard bodies each have an axial length and each sleeve is formed of two sleeves composed of two materials arranged axially relative to the hard body.

18. A method for removing a hard body from a surface of a grinding roller as claimed in claim 11, comprising the steps:
welding a device onto the sleeve for fastening a tool to the sleeve,
pulling the sleeve with or without the hard body from the surface of the grinding roller,
insofar as the hard body remains in the surface of the grinding roller, pulling the hard body from the surface of the grinding roller.

19. A method for removing a hard body from a surface of a grinding roller as claimed in claim 15, comprising the steps:
heating the surface of the grinding roller up to the melting point of the sleeve,
removing the hard body from the surface of the roller by pulling.

20. A method for removing a hard body from a surface of a grinding roller as claimed in claim 16, comprising the steps:
dipping of the grinding roller into an electrolyte solution,
connecting the grinding roller to an electrical voltage source, the grinding roller being connected to the anode,
connecting a counterelectrode to the same voltage source, the counterelectrode being connected to the cathode,
anodic oxidation of the sleeve in the electrolyte solution.
